(19) United States
(12) Patent Application Publication
(10) Pub. No.: US 2026/0267320 A1
(43) Pub. Date: Sep. 10, 2026

(54) Semiconductor Manufacturing Process with Simulated Process Window Model

(71) Applicant: Robert Bosch GmbH, Stuttgart (DE)

(72) Inventor: Peter Ebersbach, Radebeul (DE)

(21) Appl. No.: 19/166,205

(22) PCT Filed: Mar. 4, 2024
(86) PCT No.: PCT/EP2024/055580

§ 371 Date: Sep. 17, 2025

(30) Foreign Application Priority Data
Mar. 31, 2023 (DE) 10 2023 203 018.7

(51) Int. Cl. G05B 19/418

(52) U.S. Cl. CPC G05B 19/41875; G05B 19/41885; G05B 2219/32188; G05B 2219/32194; G05B 2219/32368

(57) ABSTRACT

The disclosure relates to a method for determining a process window for an R2R controller for producing one or a plurality of components in a production process, comprising the following steps: Defining first value ranges for the production machine configurations of downstream production processes. Predicting an influence on a final measurement result of the component on the basis of the first value ranges using trained data-based models, in particular regression models. Selecting the downstream process step which, according to the prediction, has one of the greatest influences on the final measurement result. Determining a modified process window for the selected process step such that the final measurement result lies in a specified interval.

The invention relates to a method for semiconductor manufacturing process tuning with a simulated process window model and in particular with a wafer material process history for verifying product specifications as well as to an apparatus, a computer program, and a machine-readable storage medium configured so as to carry out the method.

### Prior art

It is known to use Advanced Process Control ARC-R2R to adjust at least one process-guiding parameter for a process step during the production of semiconductor components.

Based on the physical measurements (so-called inline measurements), a recipe for the next processing step (process step) of the wafer is then recommended by means of a R2R controller in order to possibly readjust the next processing step accordingly if the measurements are not within a specified ideal range.

The R2R controller essentially serves to compensate for interference variables, e.g. longer-term drift in manufacturing, by means of corresponding recipe adaptations during downstream processes in order to thereby maintain relevant in-line parameters at the respective desired target variable.

One limitation of the R2R controller is that the R2R controller responds singularly or in a limited manner to a portion of the process history. A further limitation of the R2R controller is that its target variables are, in the first approximation, single process-based. However, an isolated process-stabilizing consideration of the in-line variations of previous processes is not always true, because influences from previous processes are regularly non-linear. Thus, the previously isolated optimization of the individual processes is not optimal with respect to the product.

Typically, the product development department has the freedom to use certain design elements from the PDK technology that result in certain process window usage and specification bands. It can occur that product-based features are nonetheless outside a process window of the technology, because influences related to production technology have not been considered.

### Advantages of the Invention

One advantage of the invention is that uncertainties in wafer processing with respect to product-specific specifications are reduced. This allows a more reliable wafer processing to be achieved.

A further advantage of the invention is that a consistency can be achieved in the specification limits between the technology level on one side and product-specific specification. sheet settings on the development side. Specifications indeed only use a certain range of technology, which results in a full use of the technology specs in yield loss that lie outside of the product specification. Based on a determination of a process window using a multivariate optimization between process and component parameters, process targets can be determined in a product-specific manner and ultimately complied with.

### Disclosure of the Invention

In a first aspect, the invention relates to a method for determining a process window for an R2R controller for producing one or a plurality of components, in particular semiconductor components, such as sensors or chips, in production. The process window is a parameter range of a single process from a sequence of processes. The processes can be understood as production steps.

The method can begin by obtaining a detected variable, in particular a physical or virtual measured value. The detected variable has been detected after a production process has been carried out on the component and characterizes a preferably electrical property of the component. It is then checked whether the detected variable deviates from a specified reference. As soon as there is a deviation, the following steps are taken:

Defining first value ranges for the production machine configurations of downstream production processes. A maximum value range can be taken from a documentation of the respective production process. It is conceivable that the maximum value range is reduced based on framework conditions related to production technology. Subsequently, there is a predicting of an influence on a final measurement result of the component on the basis of the first value ranges using trained data-based models, in particular regression models, according to a product specification. Then, selecting the downstream process step which, according to the prediction, has one of the greatest influences on the final measurement result. This is followed by determining a modified process window for the selected process step such that the final measurement result lies in a specified interval for final measurement results.

Optionally, the selected process step is carried out on the basis of the modified process window, preferably at least the process steps up to and including the selected process step are adjusted by the R2R controller on the basis of the modified process window and preferably carried out accordingly. Optionally, a use of the obtained process window can be carried out in a semiconductor factory. The R2R controller can determine a new control on the basis of a process history from the factory, measurements, and the process window. That is to say, the process window can be used in order to adjust a process control that can be used during manufacturing of a component in the production process for controlling a production machine. The component is preferably a semiconductor component, such as a sensor or chip. It should be noted that the process control determined according to the method of the first aspect can be used in order to manufacture one or a plurality of components. For example, semiconductor components on a wafer or in a lot/batch can be processed substantially equally according to the determined process control.

That is to say, the method allows for a consideration of the production as an overall system while taking into account the product specifications. Process windows are preferably the permitted variation of the manufacturing process for the permitted variation (USL-LSL) of the technology or product variability. Process windows can be used in different hierarchies: EWS->PCM; PCM->INLINE; INLINE->PROCESS_PARAMETERS. It is conceivable that process windows are determined using experiments, as well as via methods of simulation. Parametric Control Monitoring (PCM) ensures that the general functionality of the product is achieved. Overall, data represents all deviations occurring from the production process in the form of electrically measurable parameters. Product specifications define a certain functional product design and are used in the Electrical Wafer Sort (EWS) test. USL-LSL (BIN classes) move within technological specifications (PCM). Process deviations are determined using measurement tasks and are represented as in-line variations. The parameters used as a reference to characterize the process as well as to evaluate product-specific criteria in timely manner in the manufacturing process.

It is proposed that the predicted influence is a sensitivity of a change in the production machine configurations with respect to a predicted change of the final measurement result.

Furthermore, it is proposed that the data-based models have been trained as follows: Training of data-based models using training data, wherein the training data consists of input variables and respectively associated output variables, wherein the input variables characterize a production machine configuration and the output variables characterize a property of the component, in particular processed with the production machine configurations according to the sequence of the production steps, and preferably the output variable is the final measurement result.

The data-based models are trained to predict a respectively associated output variable on the basis of one or a plurality of the input variables, wherein in particular the training data has been determined on the basis of a simulation.

The solution verifies product-specific electrical powers (V_gsth ; Q_gd ; C_rss ; V_bd, . . . ) based on the process window behavior of the technology, simulated using TCAD models used in a Gaussian Process prediction model (or a different regression model) in order to set the piece process target value of the process based on the Wafer process history.

Further advantageous embodiments of the first aspect of the invention are the subject of the dependent claims.

In further aspects, the invention relates to an apparatus and to a computer program, which are each configured so as to carry out the aforementioned methods, and to a machine-readable storage medium on which said computer program is stored.

Embodiments of the invention are explained in greater detail below with reference to the accompanying drawings. In the drawings:

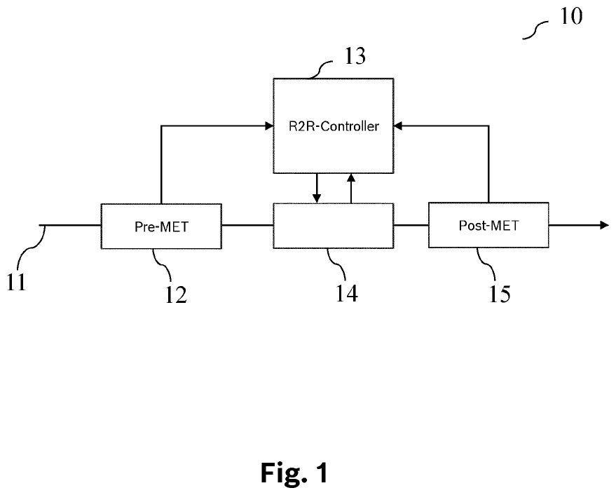

FIG. 1 schematically shows a known R2R controller;

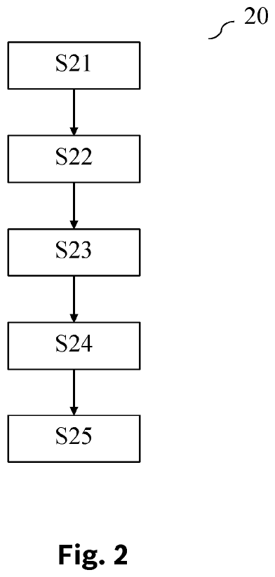

FIG. 2 schematically shows an embodiment of the inventive method for process window optimization; and

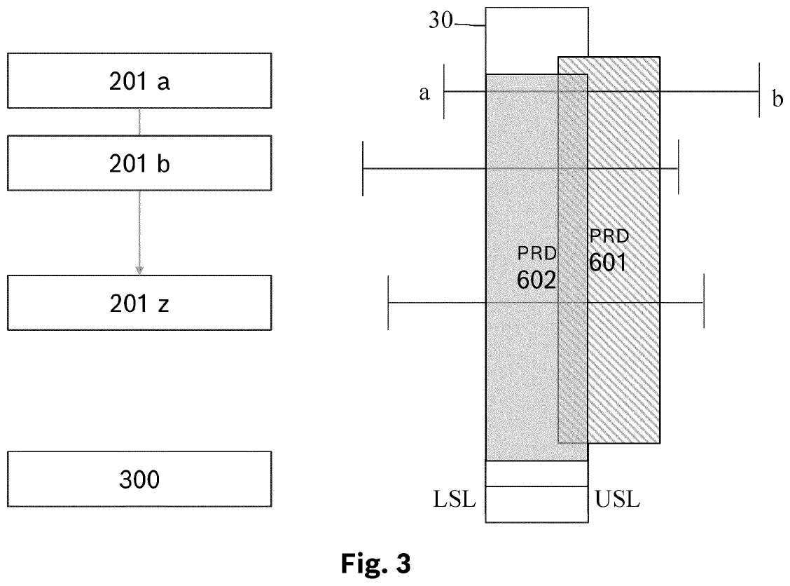

FIG. 3 schematically shows an embodiment of an optimized process window.

### DESCRIPTION OF THE EXEMPLARY EMBODIMENTS

FIG. 1 schematically shows an information flow diagram 10 of an R2R controller 13, which is known from the prior art.

The information flow diagram 10 shows a process flow 11 for manufacturing a semiconductor component. In a first step, one or a plurality of physical measurements 12 are carried out on a wafer. A measurement 12 can be a thickness, width, depth, etc. of the wafer. The measurement results MET are then forwarded and provided to the R2R controller 13.

Depending on the measurement results MET, the R2R controller 13 will adjust a process step 14 for the wafer. In other words, the R2R controller 13 outputs an adjustment for the process step 14 on the basis of the measurement results MET so that, after performing the process step 14, the processed wafer ideally has product parameters within a specified value range.

Optionally, after performing process step 14 according to the adjustment output by the R2R controller 13, one or a plurality of downstream physical measurements 15 can be carried out on the processed wafer. The measurement results obtained post-MET can be provided to the R2R controller 13 as feedback so that the latter can provide better adjustments for downstream process steps 14, on the basis of the subsequently obtained measurement results.

In summary, it can be said that the R2R process control according to FIG. 1 comprises a pre-measurement, processing, and optionally a follow-up measurement. The R2R controller 13 pursues a control target: setting process parameters (controlled variables) within specification limits based on a target value and automatically correcting, in a model-based and self-learning manner, target deviations by the targeted adaptation of manipulated variables, e.g. processing time, gas flows, etc.

FIG. 2 schematically shows an embodiment of a method for determining a process window for an R2R controller (13).

The method begins with a provision of data S21, which is subsequently used in order to determine an optimal process window. Preferably, the following data is provided:
1. A product data sheet of the semiconductor component to be manufactured. The product data sheet contains a specification of the semiconductor component, the compliance of which is absolutely necessary, e.g. switching frequencies or parasitic capacities within specified intervals, drop voltage, and other product-specific parameters.
2. TCAD simulation model (representative image of the flow technology for manufacturing the semiconductor component). The simulation model models a process chain for manufacturing the semiconductor component and simulates product parameters of the semiconductor components manufactured according to the modeled process chain.
3. Optionally, real data from manufacturing can be provided for qualification/validation of the simulation model. The manufacturing data can be measurements MET_n with preferred parameters from the factory. It is conceivable that the real data will be used in addition to or as an alternative to calibration of the model of the simulation.
4. Optionally, a process history, i.e. measurement results of the individual processes (in-line measurement result, MET_n) and/or process sensor values (FDC_n=temp, pressure; gas flows, energy, power . . . ) can be provided. In addition or, as an alternative to, the process history, a wafer history. can be provided. The measurement results can be acquired, for example, using the following measurement methods: layer thickness measurement (THK), e.g. spectroscopic ellipsometry of multiple superimposed transparent layers, structural measurement by atomic force microscopy (AFM), e.g. trench depth, imaging methods (CDSEM), e.g. geometric width, hole diameter, critical dimension, defect number and pattern, (DFU), resistance measurement (RES), specific resistance.

After the data has been provided or obtained in step S21, step S22 follows. Herein, a training data set is generated in a simulated manner by means of TCAD. For this purpose, corner cases of the individual process steps of the modeled process chain, in particular process windows of these individual process steps, and preferably further meaningful points to be simulated are first defined. The corner cases can be derived from the product data sheet and/or production technology limits. The further points to be simulated can be combined with a so-called Space Filling Design. Subsequently, in step S22, the points that have just been defined are simulated using TCAD. The simulation collects the simulation results for the defined points. The data obtained with the simulation is stored together with all simulated points into a training data set. Preferably, the training data set is constructed by two data point sets that are associated with one another. The training data set consists of a first quantity of input information and a second quantity of output information. The input information consists of the points to be simulated and can characterize individual processes, such as etching duration, dose, energy for implantation, geometrical variations, temperatures, gas flows. At least one piece of output information is associated with each piece of input information. The output information is e.g. voltages (e.g. V_th), switching frequencies, capacitances, resistances, behavior of the semiconductor component. It is conceivable that the training data set can be in a form of a data table or other tabular representation between input information and output information.

After the simulation step S22 has been completed, in the following step S23, a data-based model is created. The data-based model can be a Gaussian Process (GP) model or a different model of machine learning, such as a (linear) regression model or neural network. Preferably, the data-based model is a GP, because it can learn non-linear connections from a small amount of training data and can thus provide a high accuracy and can output an uncertainty of its prediction.

In step S23, the data-based model is trained on the training data set from step S22. In a further embodiment of the method 20, a plurality of data-based models are trained in step S23. In so doing, the data-based models can obtain one or a plurality of the pieces of input information as input variables and are trained to predict one of the pieces of output information based on the respective input variables. It can therefore be said that, in step S23, the data-based model has learned an association between input information and output information. Known training algorithms for the various data-based models can be utilized for the training. In a further embodiment of step S23, wafer history and/or process history data are used as additional input for the data-based model.

Optionally, in the following step S24, a visualization of the corner cases and the predictions of the data-based models can be carried out.

After the training of the data-based models has been completed, it will now be explained how the learned data-based models are used by the R2R controller 13.

In step S25, an optimization of a multi-dimensional process window is carried out using the R2R controller 13 and the data-based models from step S23. It can be a goal of the optimization to find all solutions with reference to the permitted parameter space based on defined optimization criteria.

In a first embodiment of the optimization, a plurality of parameter combinations can be created. In so doing, the learned data-based models are used in order to predict the respective output information, given the parameters of the input information. Subsequently, the value ranges are filtered out in order to meet the specification of the product data sheet. The step of filtering out occurs for all optimization targets. Subsequently, all filtered-out value ranges are compared to or superimposed on one another so that a final parameter interval 30 is given which lies within the product specifications, see FIG. 3.

Based on the process history and the expected values of downstream processes, a prediction related to component parameters can be made with the data-based models. Deviations, as a difference between the target and the data point determined from the model, can be corrected by individual process changes. Thus, it can be ensured that process adjustments are always made with reference to the specification of the product data sheet, with the background of the process window relationships between the manufacturing process and the product specification.

FIG. 3 schematically shows the above-described procedure for finding the final parameter interval 30. On the left-hand side of FIG. 3, the individual process steps 201a, . . . , 201z and a final measurement step 300 are shown. To the right, respectively at the level of the process steps 201a, . . . , 201z, the intervals a, b for the associated technology process corner cases are depicted. For the measurement step 300, the interval between LSL and USL results from the product data sheet. The interval between LSL and USL defines a process window. The windows PRD 601,602 are each windows of different products. The window PRD 601 is substantially congruent with the parameter interval 30 for maintaining LSL and USL. However, a portion of the window PRD 602 lies outside of the parameter interval 30 for maintaining LSL and USL. In this case, the R2R controller will need to engage in a controlling manner according to step S25, so that the component again lies within LSL and USL after passing through the process steps 201a, . . . , 201z.

1. A method for determining a process window for an R2R controller for producing one or a plurality of components in a production process, comprising:
detecting that a measured value after a production process has been carried out on the component, and which characterizes a property of the component, deviates from a specified reference value for this measured value;
defining, in response to the detecting, first value ranges for production machine configurations of downstream production processes of the component;
predicting an influence on a final measurement result of the component on the basis of the first value ranges using trained data-based regression models;
selecting a downstream process step which, according to the prediction, has one of the greatest influences on the final measurement result; and
selecting a second value range for the selected downstream process step such that, use of the selected second value range with the selected downstream production process results in the final measurement being in a specified interval.

2. The method according to claim 1, wherein the measured value is detected after a first production process from a sequence of production processes, and is an electrical measurement.

3. The method according to claim 2, wherein the predicted influence is a sensitivity of a change in the production machine configurations with respect to an expected change of the final measurement result.

4. The method according to claim 1, wherein the trained data-based regression models are Gaussian Processes.

5. The method according to claim 1, wherein the trained data-based regression models have been trained as follows:
training of data-based models using training data, wherein
the training data consists of input variables and respectively associated output variables,
the input variables characterize a production machine configuration and the respectively associated output variables characterize a property of the component,
the data-based models are trained so as to predict one of the respectively associated output variables on the basis of one or a plurality of the input variables, and
the training data has been determined using a simulation.

6. The method according to claim 1, wherein the second value range is provided to the R2R controller and an adjustment of a process control for the production processes occurs on the R2R controller on the basis of the selected second value range and further measurement results.

7. An apparatus which is configured so as to carry out the method according to claim 1.

8. A computer program consisting of instructions which, when the program is executed by a computer, prompt the latter to carry out the method according to claim 1.

9. A machine-readable storage medium on which the computer program according to claim 8 is stored.
